(19) United States
(12) Patent Application Publication
(10) Pub. No.: US 2005/0056142 A1
(43) Pub. Date: Mar. 17, 2005

(54) Musical effects control device

(76) Inventors: David Bernard Mapleston, Wiltshire (GB); Daniel Steinhardt, Swindon (GB)

Correspondence Address: JOEL D. SKINNER, JR.;SKINNER AND ASSOCIATES, 212 COMMERCIAL ST., HUDSON, WI, 54016, US

(21) Appl. No.: 10/937,997

(22) Filed: Sep. 10, 2004

(30) Foreign Application Priority Data
Sep. 13, 2003 (GB) GB 0321552.2

(51) Int. Cl. G10H 7/00

(52) U.S. Cl. 84/645

(57) ABSTRACT

A musical effects control device as shown in FIG. 1 for use, primarily but not exclusively, by guitarists, will manage a stage or studio performance, with no off stage equipment, by connecting and disconnecting a combination of a plurality of external analogue or digital sound effects devices, which have not been specifically designed to work with this invention, using true bypass techniques, setting the volume to a pre set level for each combination of effects, controlling which of a number of amplifiers will be used and controlling a number of amplifier channel controls and functions, all selected in an instant using one of a number of hand or foot operated switches as shown in FIG. 1, 2.

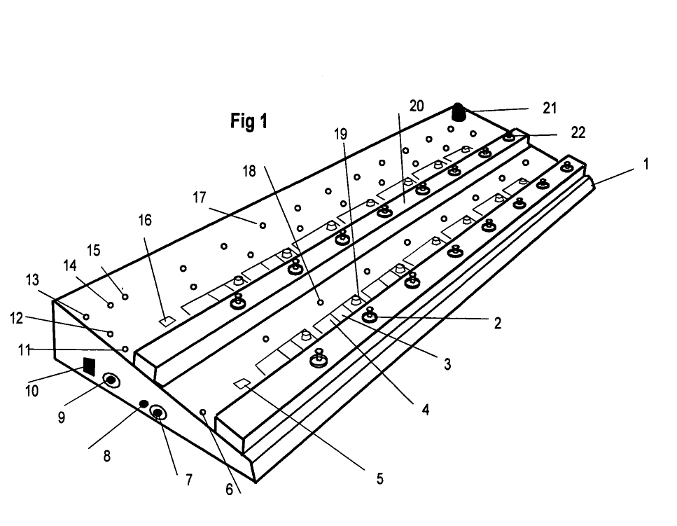

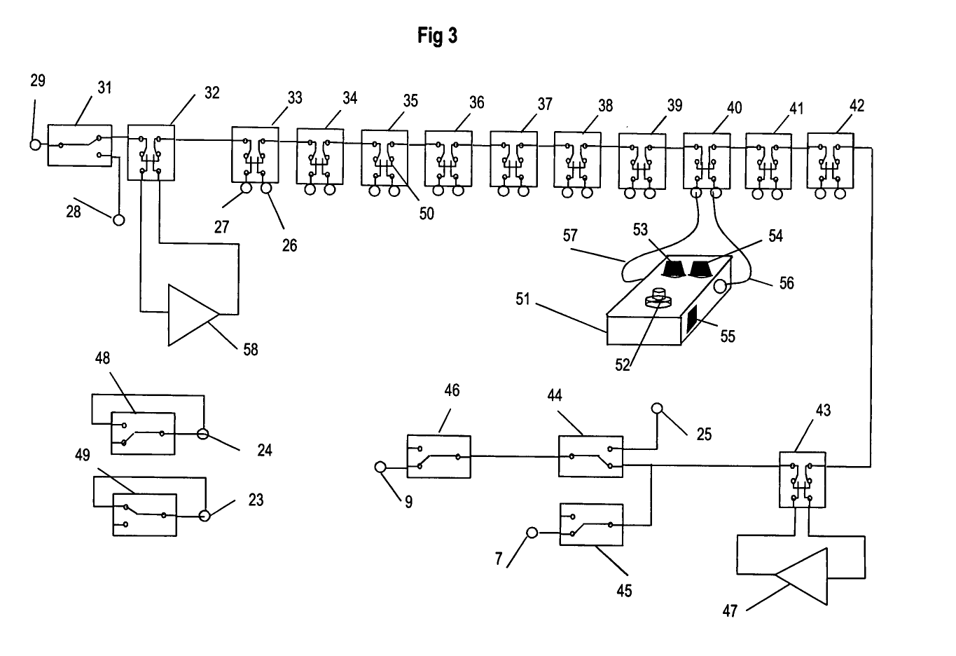

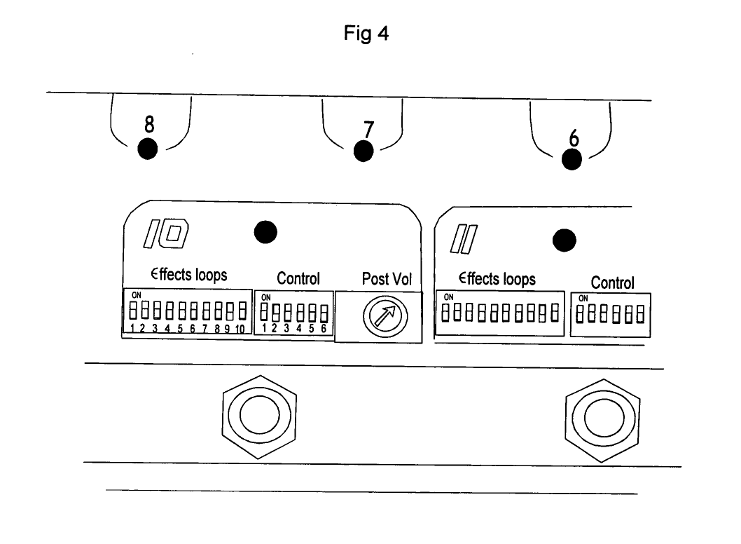

This invention relates to a sound effects controlling device FIG. 1, 1. The invention controls external sound effects units FIG. 3, 51 that have not been specifically designed to work with the invention and can be bought in any good guitar shop. This invention is primarily but not exclusively for use by guitarists. One embodiment of the invention is shown in FIG. 1, 1, it can be hand or foot operated during a studio or stage performance, using switch means FIG. 1, 2. A preferred embodiment of the invention can be pre programmed by switch means FIG. 1, 4 (shown in detail in FIG. 4). These switches control a plurality of musical effects units FIG. 3, 51 and can retrieve up to fourteen combinations of ten effects in an instant. Each combination of effects also has an associated volume level. This volume level can be saved and recalled, with each combination.

Sound effects devices FIG. 3, 51 for guitarists and other musicians have been known for many years. These sound effects devices commonly comprises of a box with an on/off switch FIG. 3, 52 signal input FIG. 3, 57, signal output FIG. 3, 56 and power supply input FIG. 3, 55.

Controls on these effects units are commonly used to adjust the amount of effect to be applied to the sound FIG. 3, 53, and the output volume of the effects unit FIG. 3, 54.

The most commonly used sound effects are echo, distortion, Wah, compression, phasing, modulation, noise gating, reverberation, tone changing and chorus. These effects units manipulate the electrical signal from the instrument, microphone or other sound source to change the characteristics of the sound. Most good guitarists will already have a collection of these effects units, however, due to the difficulties of managing these effects on stage, only three or four are commonly use within a performance. These existing effects have therefore not been designed to work with this invention.

In the recording studio or in high-level stage performances, expensive equipment is commonly used to control the previously described sound effects units. This studio equipment can take the form of floor mounted control switch boxes that communicate to rack mounted or other specially constructed switching units. The communication between the floor controller and the switching unit is commonly the standard music serial interface protocol MIDI. This switching equipment is generally located off the stage and is primarily configured for use by qualified audio technicians. This equipment is generally too complex and costly for use by the average stage-performing musician.

According to the present invention there is provided a single unit, which will control and manage externally connected musical effect units and other equipment used for a musical stage performances. This invention brings simplicity of use and affords studio quality audio to the stage performance at affordable cost for the average stage-performing musician.

In recent years digital multi effects units have become more popular. These devices do provide instant retrieval of sound effects; however, due to the fact that the signal within these units is digitized and then mathematically manipulated before reconstruction back into a sound carrying signal. It is widely regarded that they do not afford the quality of sound achieved by analogue effect units as the original tone of the instrument suffers under the digitization process.

Some of the signal degradation problems associated with digital audio effects are: noise (hiss), quantisation noise, time delay and aliasing effects.

According to the present invention there is provided a unit FIG. 1, 1 which achieves the storage and instant retrieval capabilities of the digital multi effects devices whilst providing the sound quality associated with analogue effects units FIG. 3, 51. This is achieved by using and controlling, external analogue effects units FIG. 3, 51, not designed specifically for this invention and connected to this invention by standard guitar jack plug leads. These effects are controlled using switching means FIG. 1, 4 and switching means FIG. 3, 33 to FIG. 3, 42.

Analogue effect units FIG. 3, 51 are commonly connected in series; the output of one effects unit is connected to the input of the next and so on. This method is known to cause sound quality degradation, primarily due to imperfections in the impedance matching and bandwidth of each unit, this sometimes occurs even when the effects units are switched into a bypass mode.

According to the present invention, this problem is minimized as only the effects used for the required sound are connected into the signal path. The unused effects are bypassed using a switching means, shown for example in FIG. 3, 33. One embodiment uses relays FIG. 3, 33 to switch out the unused effects; the effects units which are not required for the chosen sound are therefore physically disconnected from the signal path and hence do not degrade the sound quality.

In another embodiment the signal from the sound source is buffered and fed to all the inputs of the effects units simultaneously. The outputs of the effects units are volume adjusted and then combined by a summing or mixing means to provide a combined output signal.

A common problem faced by stage or studio-performing guitarists is best described as, a tap dance! This tap dance is required to switch either in or out the effects to be used for the next song or phrase (section of a song). This tap dance takes time and hence distracts both the audience and musician, degrading the musical performance. Also, occasionally the musician may make a mistake, switching the wrong combination of switches resulting in the wrong sound and hence embarrassment.

According to the present invention there is a means to store the combinations of effects required for each song or phrase on switch means FIG. 1, 4. The musician retrieve this stored pattern at any time using switch or button means FIG. 1, 2. The pattern of effects is clearly indicated on the switches themselves and this pattern will obviously remain when power is removed from the unit.

An important inventive step is a volume control associated with each combination of effects. These volume controls are designed in such a way that they do not require the audio signal to pass through them. Instead, they control the volume of an optically controlled amplifiers within the audio signal path. Up to 14 combinations of sounds and sound volumes can be pre set within the preferred embodiment shown in FIG. 1. This enables the musician to pre set both the combination of effects that will be used for each sound and the output volume level of the sound to be presented to the amplifier. FIG. 1, 4 shows the switch means for setting the effects combination for each sound and FIG. 1, 19 shows the volume preset control means for the selected sound volume level for that combination. FIG. 1, 2 shows the switch or button means used to instantly retrieve the required sound and volume level.

The present invention solves another common problem, which relates to the use of both digital and analogue effect units. Guitar maximum output signal levels vary widely from guitar to guitar; more so between guitars from different manufacturers. Sound effects units are sensitive to this input signal level, giving a noticeably different sound and sound quality at these different input levels.

The present invention has means for adjusting the input volume from the musical instrument or music source. In addition this amplification or attenuation can be used or bypassed for each combination of effects, this master input level can be pre set by the user with control means FIG. 1, 21. In another embodiment, this input level control is associated with each combination of effects in the same manor as the output volume control. For the preferred embodiment FIG. 1, 1 we would have two volume control presets FIG. 1, 19 for each switch or button FIG. 1, 2. One to preset the input volume and one, as is, to set the output volume.

Within a performance a musician may require the sound to be routed to one or more amplifiers. The present embodiment of this invention has means to pre select the output path of the signal to both or either one of two outputs FIG. 1, 7 and FIG. 1, 9 using switch means FIG. 1, 3. These two outputs are also automatically configured as left and right channels, when a stereo effect unit is used. In the present embodiment one output passes through an isolation transformer. This prevents earth loops between equipment and hence reduces mains hum.

Some amplifiers are sold with foot switch controls. These controls affect the amplifiers sound in various ways; for example, to select different amplifier channels or to switch in or out the amplifiers internal reverberation unit. Often the musician will need to find this switch, which may be on the amplifier itself, or on the floor as mentioned previously. Finding and operating this switch can distract the musician and degrade the stage performance.

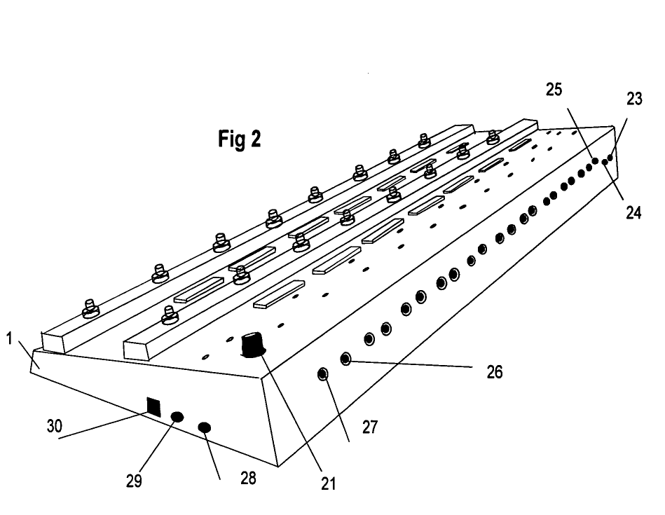

The present invention has means to control the switching of the amplifier. Two control outputs are provided, FIG. 2, 23 and FIG. 2, 24 these again can be pre programmed before the performance using switch means FIG. 1, 3. According to the present invention the musician can select and configure the amplifier to be used for the required sound, instigate a new pattern of external effects units and recall the input and output volume levels in an instant. All this is achieved with one single button press. This provides the musician with the means to accomplish a seamless performance that includes a myriad of sound effect without compromising audio quality.

Commonly effects units require a supplied of 9V DC; the present embodiment of this invention has an output FIG. 2, 30 to provide the required supply for the external effects units FIG. 3, 51.

During a performance a musician may require to re tune his/her instrument. Today this is commonly achieved using an electronic tuning device. The tuning process usually involves disconnecting the instrument from the system and then connecting the instrument to the tuning device and then after tuning is complete, the instrument must be re connected to the system.

The present invention has an auxiliary output facility FIG. 2, 28 to which a tuning device can remain connected. The signal from the instrument can be routed to the turning device by one single button press FIG. 1, 22. After tuning, the musician can returned to the system sounds by a single button press of one of the fifteen remaining buttons FIG. 1, 2. The output to the amplifier or amplifiers is silenced within the tuning phase, preventing the audience from being subjected to the tuning sound.

The present invention is primarily, but not exclusively, intended for the control of analogue sound effects units; a combination of both analogue and digital effects units can be controlled.

According to the present invention, there is provided a means to minimize the unwanted popping sound associated with switching analogue effects units on and off. Within the present embodiment, this is achieved using a microprocessor to detect that a change in the pattern of effects has been instigated by the musician. Before the effects units are disconnected the outputs of the effect controller are disconnected and hence muting the sound. After the switching process is completed and the new pattern of effects units are connected together the outputs are then first shorted to ground for a set time to remove unwanted DC, they are then reconnected to the amplifier.

FIG. 1 shows the present embodiment with a multitude of Light Emitting Diodes (LEDs) FIG. 1, 6,11,12,13,14,15,17 and 18. These LEDs show the functional status of the effects control unit. In another embodiment, the functional status of the effects controller is indicated to the user using a display means. For example an LCD (liquid crystal display).

According to the present invention, a means for one effects controller to communicate to and control other effect controllers has been implemented. In the embodiment described this communication is a simple try-state bi-directional pulse protocol, the output and input of which is shown in FIG. 1, 8.

In another embodiment, the communication between the present effects controller and other equipment is the standard music interface protocol MIDI.

In the present embodiment of this invention the effects controller has its own self-contained musical effects and can introduce them into the signal path. These effects can be combined with the existing combination of external effects to create complex sounds. The introduction of internal effects is well known in the art and not claimed as an inventive step.

According to the present invention there is provision for the user to access other functions and features controlled by the internal microprocessor or microprocessors. These features are accessed by holding down the switch means shown in FIG. 1, 2 for a number of seconds. Each of the 16 switches or buttons can be used in this manor to select one of 16 functions. These special functions could include features such as enabling or disengaging, internally stored effects, anti pop circuits, self test routines, creating set patterns of sound effects, enabling internal tuning devices, enabling internal radio transmit and receiver devices, enabling an internally generated metronome, enabling internal drum sound effects. Setting the brightness of the display means, setting the contrast of the display means and informing the user of the status of various setting.

In another embodiment holding down two or more of the switch means FIG. 1, 2 accesses internal functions.

Guitarist will in general use more than one guitar for a performance. Changing guitars involves unplugging one guitar and then connecting in the next guitar then resetting the volume level and changing the amplifier channel selection switches before playing. This takes time and is an annoyance to the guitarist and audience.

According to the present invention a single unit which will select one of a number of instruments, up to ten in the present embodiment, whilst disconnecting the previous instruments from the signal path. The present embodiment FIG. 1, 1 uses relays to achieve true bypass. The volume level and amplifier controls for each guitar can be pre set using preset means FIG. 1, 19, The guitar, its preferred volume and amplifier control relays FIG. 3, 48 and FIG. 3, 49 can be recalled in an instant using switch means FIG. 1, 2. The guitars would be plugged into the right-hand side of the relays FIG. 3, 33 to FIG. 3, 42 For example FIG. 3, 26 would be a guitar input.

Music shops, when selling electric or electrified acoustic guitars are required to connect and disconnect guitars to and from amplifiers on a regular basis. The present embodiment of this invention allows up to 10 guitars to remain connected at all times. One button press FIG. 1, 2 would connect the chosen guitar to the amplifier and then set the volume level and configure the amplifier all in an instant. This would enhance sales as the customer could do quick comparisons between instruments.

Music shops, when selling amplifiers are required to connect and disconnect a guitar to a number of amplifiers on a regular basis. The present embodiment of this invention allows up to 10 amplifiers to remain connected. One button press FIG. 1, 2 would connect the guitar to one of 10 amplifier, set the volume level and configure the amplifier all in an instant. This would enhance sales as the customer could quickly compare amplifiers. In this configuration the guitar is connected to the input FIG. 2-29, FIG. 3, 29 and the amplifiers are connected to left hand side of the relays shown in FIG. 3, 33 to FIG. 3, 42. For example FIG. 3, 27 would be an output to one of the amplifiers.

A preferred technical description of the effects controller invention will now be described using the diagrams:

FIG. 1 a front perspective view of the present embodiment, showing foot switches and controls.

FIG. 2 a rear perspective view of the present embodiment, showing foot switches controls and sockets for the attachment of external effects units etc.

FIG. 3 a schematic view of the signal path used in one embodiment of the invention.

FIG. 4 is an enlargement of part of the embodiment of FIGS. 1 to 3.

A microprocessor is used to detect which of the 16-foot switches have been pressed, the microprocessor then controls 14 power transistors which can each power all the relays show in FIG. 3.

The relay switching current flows through switching means FIG. 1, 3 and FIG. 1, 4 to each relay. The states of the said switches will therefore determine whether the relays will operate or not operate and in turn cause the selected effect unit or internal function to be selected or bypassed. The external effects, when not used, are bypassed by links FIG. 3, 50.

The present embodiment uses relays so as to claim ‘true bypass’. True bypass is known to experts in the field to mean the bypass path or paths will not contain any valve or semiconductor electronic device. The reason for this is that these active elements can cause signal degradations. With the present embodiment the musician can be assured that when all the effects are switched off his/her instrument or music source is physically connected to the amplifier or sound system. If this feature is not considered important another embodiment for this invention can use semiconductor analogue, switches or other semiconductor switch means to perform the function of the relays shown in FIG. 3.

The Microprocessor implemented within the present embodiment provides many other house keeping functions. One of these functions is to monitor the switches shown in FIG. 1, 5. These switches change the function of the switch means FIG. 1, 2. This allows switch means FIG. 1, 2 to remain on whilst other switches are selected. This allows the sound effects created by the external effect units to be added together to form yet more complex sounds.

The mechanical features of this embodiment are also important. To maintain ultimate reliability, two strong rails FIG. 1, 20 have been used to maintain rigidity under the pressure of the user's foot.

Another important mechanical feature reduces the effect of the box distortion caused by the foot pressure. Normally this distortion would be transferred through the metal case to the printed circuit board. Reduction in this stress is achieved by floating the printed circuit board on the bottom of the switches. The printed circuit board can therefore move with the switches which in turn move when the box distorts, allowing this movement dramatically reduces the forces on the PCB and switch body.

FIG. 3 shows the signal path for one embodiment of this invention. This signal path will now be described from the signal input to the signal output.

The instrument or music source is fed into the effects controller at input FIG. 3, 29. If relay FIG. 3, 31 has not been activated by the switching means FIG. 1, 22 the signal will continue to relay FIG. 1, 32. Otherwise if relay FIG. 3, 31 is powered the signal will be routed to the auxiliary output FIG. 3, 28. This output can be used for a tuning aid, another amplifier, another effects controller or other electronic equipment.

Relay FIG. 3, 32 when not selected by switch means FIG. 1, 3 will connect the signal to relay FIG. 3, 33. When powered relay FIG. 3, 32 will rout the signal through amplifier means FIG. 3, 58 to relay FIG. 3, 33. The gain of this amplifier is controlled by adjustment means FIG. 1, 21. When relay FIG. 3, 32 is activated the LED (Light Emitting Diode) adjacent to volume control means FIG. 1, 21 will illuminate to show the user that the amplifier is in the signal path and hence the input volume control will operate for the selected sound.

Relay FIG. 3, 33 is the first in a chain of 10 relays ending in relay FIG. 3, 42. Each relay when powered through switch means FIG. 1, 4 will connect the external effects unit FIG. 3, 51 into the signal path. For example if the eighth relay in the chain was powered by switch means FIG. 1, 4, the external effects unit FIG. 3, 51 would then be added into the signal path. LED FIG. 1, 17 will illuminate to show the user that effect unit 8 is connected into the signal path.

FIG. 3, 57 shows the input connection for the effects unit and FIG. 3, 56 shows the output lead for the effects unit.

The last relay to which an external effect unit can be introduced into the signal path is relay FIG. 3, 42, from this relay the signal is passed to relay FIG. 3, 43.

Relay FIG. 3, 43 when un-powered will pass the signal to relay FIG. 3, 44; however, when relay FIG. 3, 43 has been powered by switch means FIG. 1, 3 the post effects amplifier FIG. 3, 47 is connected into the signal path. This is indicated to the user by the illumination of the LED FIG. 1, 13.

The gain of amplifier FIG. 3, 47 is controlled by the post effects volume control FIG. 1, 19 this volume level is indicated to the user by the brightness of light emitting diode FIG. 1, 12.

According to the present invention amplifier FIG. 3, 47 is optically gain condoled by a light source whose brightness is proportional to the setting of the preset means FIG. 1, 19. This optical method alleviates the need to rout the signal path to each preset location, this simplifies the signal path routing which in turn reduces cross talk and improves immunity to electrical interference.

Relay FIG. 3, 44 provides the stereo output option. When not powered it passes the signal to relay FIG. 3, 46. When powered the signal from the stereo input FIG. 3, 25 FIG. 2, 25 is routed to the output FIG. 3, 9 FIG. 1, 9. Relay FIG. 3, 44 it powered automatically when Relay FIG. 3, 42 is activated and a jack plug is inserted into socket FIG. 3, 25 FIG. 2, 25.

The signal from relay FIG. 3, 43 also passed to relay FIG. 3, 45, this relay when not powered will pass the signal to the output FIG. 3, 7. When powered this relay will disconnect the signal from the amplifier and so act at a mute. Light emitting diode FIG. 1, 6 will illuminate to indicate that the output FIG. 3, 7 is un-muted.

Relay FIG. 3, 46 when not powered will pass the signal to the output FIG. 3, 9 FIG. 1, 9. When powered this relay will disconnect the signal from the amplifier and so act as a mute. Light emitting diode FIG. 1, 10 will illuminate to indicate that the output FIG. 3, 9 is un-muted.

Relay FIG. 3, 48 and relay FIG. 3, 49 are not connected within the signal path; these relays are incorporated to control external equipment such as amplifiers, lighting equipment or other stage equipment. When un-powered relay FIG. 3, 48 provides an open circuit at output FIG. 3, 24 FIG. 2, 24 when powered through switch means FIG. 1, 3, relay FIG. 3, 48 will provide a short circuit at the output FIG. 3, 24 FIG. 2, 24. This will be indicated to the user by the illumination of LED FIG. 1, 15.

When un-powered relay FIG. 3, 49 provides a short circuit at output FIG. 3, 23 FIG. 2, 23 when powered through switch means FIG. 1, 3 relay FIG. 3, 49 will provide an open circuit at the output FIG. 3, 23 FIG. 2, 23. This will be indicated to the user by the illumination of LED FIG. 1, 14.

1. An effects control device comprising a housing provided with a plurality of connectors whereby a plurality of external effects devices can be connected thereto, a signal input and a signal output, a plurality of switch means, and a microprocessor operable under the control of the switch means arranged to control which of the external effects devices are connected between the signal input and the signal output at a given time.

2. A device according to claim 1, further comprising a memory associated with the microprocessor, the memory being non-volatile so as to allow data to be stored therein when no power is supplied to the device.

3. A device according to claim 1, wherein the control over which of the external effects devices is connected between the signal input and the signal output is made using electrical relays controlled by the microprocessor.

4. A device according to claim 1, further comprising pre-sets for gain controlled amplifier means before and/or after the selected combination of effects.

5. A device according to claim 1, further comprising means to route the output to a combination of two or more amplifiers.

6. A device according to claim 1, further comprising power output means to provide power to the external effects devices.

7. A device according to claim 1, further comprising mute means to mute the output signal over the period when the combination of effects are being disconnected or reconfigured by microprocessor.

8. A device according to claim 1, further comprising channel selection means to control the amplifier channel selection or reverberation switches on external amplifiers.

9. A device according to claim 1, wherein the microprocessor is used to switch relays which in turn select a combination of external guitar effects pedals or amplifiers or amplifier functions.

10. A device according to claim 1, where the switch means used to operate the microprocessor means can be held down for a period of time to enable other features and functions within the device.

11. A device according to claim 1, wherein the volume control for each combination of effects is achieved using a single optical gain controlled amplifier.

12. A device according to claim 1, wherein a Junction type field effect transistor (JFET) is provided to allow muting to the output signal during switching.

13. A device according to claim 1, wherein the actuation of switch means by a user is communicated to other equipment using the standard musical instrument protocol MIDI.

14. A device according to claim 1, wherein the switch means can be activated from external equipment using the standard musical instrument protocol MIDI.

15. A device according to claim 1, wherein the combination of effects required by the musician or technician can be communicated to/from other equipment using the standard musical instrument protocol MIDI.

16. A device according to claim 1, wherein the sending or receiving of switching signals and effects information is communicated to other equipment using a wireless radio link.

17. A device according to claim 1, wherein the instrument is any musical instrument which can provide an electrical representation of it's sound.

18. A device according to claim 17, wherein the instrument is a guitar.

19. A device according to claim 1, wherein the housing comprises two separate housings, one containing the switch means and the other containing means for combining the external effects.

20. A device according to claim 19, wherein communication between the separate housings is by a wireless radio means.

21. A guitar effects control device, comprising a means for microprocessor controlled selection of any combination of a plurality of guitar effects devices between the instrument and amplification means, where the external effects are sold in most music instrument shops and are originally designed to be used directly between the guitar and amplification means, several of these external effects can be connected to the control device using standard guitar leads, any combination of these external effects, to be used in a song or phrase, can be stored using switch means, and then re-called, at any time, using a number of single foot controlled switches, each combination of external effects and volume setting, being stored indefinitely, with or without power applied to the unit.

22. A guitar effects control device comprising a means for electrically connecting and disconnecting a plurality of external guitar effects devices which have not been designed specifically to work with the invention, where the controlling device has means to recall a pre set volume level for each or any combination of external effects selected into the signal path, without the audio signal passing through the said volume controlling device.

23. A guitar effects control device, with foot switches, contained within one single unit which has a means for connecting and disconnecting a plurality of separate external guitar effects devices, not specifically designed to work with the invention, between the guitar and external amplification means.

24. A device according to claim 1, wherein the switch means comprises a plurality of switches, the microprocessor being arranged such that operation of a first one of the switches connects a first selection of the external effects devices between the signal input and the signal output, operation of a second one of the switches connecting a second selection of the external effects devices between the signal input and the signal output.
